(19) United States
(12) Patent Application Publication
(10) Pub. No.: US 2015/0269268 A1
(43) Pub. Date: Sep. 24, 2015

(54) Search server and search method

(71) Applicant: BEIJING QIHOO TECHNOLOGY COMPANY LIMITED, Beijing (CN)

(72) Inventor: Dong Zhang, Beijing (CN)

(21) Appl. No.: 14/436,335

(22) PCT Filed: Sep. 22, 2013
(86) PCT No.: PCT/CN2013/083929

§ 371 Date: Apr. 16, 2015

(30) Foreign Application Priority Data
Oct. 17, 2012 (CN) 201210395000.7

(51) Int. Cl. G06F 17/30

(52) U.S. Cl. CPC G06F 17/30876; G06F 17/3053; G06F 17/30867

(57) ABSTRACT

The disclosure discloses a search server. The search server comprises an information security degree memory and a post-search processor. The information security degree memory is configured to store information on information security degree of one or more webpage, comprising at least a URL of a webpage and the information security degree of the webpage; the post-search processor obtains from the information security degree memory information on information security degree of a webpage according to the URL of the corresponding webpage in each search result item of the search result list, generates a new ranking score of a webpage according to the ranking score and the information security degree of the webpage, and updates the ranking score in a corresponding search result item in the search result list with the new ranking score so as to re-rank and generate a new search result list. The disclosure further discloses a corresponding search method.

### FIELD OF THE INVENTION

The disclosure relates to the field of network search, and in particular, to a search server and a corresponding search method considering the information security degree of network content.

### BACKGROUND OF THE INVENTION

With the rapid development of the internet, various enterprises, organizations and individuals, etc. gradually know the importance of providing information services on the internet and establish respective websites one after another to publish corresponding information. With the increase of websites providing network information services on the network, it is very difficult for an internet user to remember the particular addresses of all these websites, or even those that he wants to visit. Meanwhile, the information accommodated by the internet also grows explosively, and so far, various kinds of content on the internet may be described as vast as the open sea. In such a case, how to let an internet user find the content that he himself wants in shortest time becomes a top priority. As a result, unlike initial websites publishing various messages, a kind of websites and servers which are dedicated to search came into being. Moreover, search websites based on the internet and a variety of derivative search modes also greatly promote the development of the internet. Nowadays, an internet user relies to a great extent on a search website to query the content that he himself needs.

Generally, a search website utilizes a search engine to extract information (predominantly the webpage text) of individual websites from the internet and establishes a database. When a user queries on the search website, the search engine can retrieve records matching the query condition of the user. According to the degree of match of the search result with the query condition, each corresponding record in the search result is given a ranking score, sorting is done according to the levels of the ranking scores and returned to the user.

However, with the rapid development of the internet, the information on the internet grows explosively, various kinds of harmful and incorrect information are also increasing. When a user queries through a search website, he will often obtain incorrect, erroneous and malicious information. Some malicious persons deliberately build webpages with a Trojan, a virus, etc., and take advantage of the defects of the ranking algorithm of a search engine to make the ranking of these malicious webpages in the top in the search result. Once a user searches such webpages through a search engine and selects to browse these malicious webpages, a terminal of the user will thus be likely infected with a Trojan or a virus and thereby losses result. In addition, some malicious persons will build fake websites similar to real websites, and make use of defects of a search engine to make the ranking of the fake websites ahead of the real websites in the search result when a user is searching, which will likely guide the user to go to these fake websites and cause the user to be misled and suffer from losses.

Some existing search engines will remind a user in the search result that a corresponding webpage might contain malicious content such as a Trojan, a virus, and thereby can prevent the user from visiting these webpages. However, the existing search engines discern only malicious content, but not a webpage containing false content, which cannot meet the real demands of the user.

Therefore, how a user obtains accurate and secure information through a search engine becomes a current important challenge.

### SUMMARY OF THE INVENTION

In view of the above problems, the disclosure is proposed to provide a search server and a corresponding search method which overcome the above problems or at least in part solve the above problems.

According to an aspect of the disclosure, there is provided a search server which comprises an information memory, a search processor, an information security degree memory and a post-search processor. The information memory is configured to store webpage information collected from individual websites accessing the internet, wherein the webpage information comprises at least content of a webpage and its URL. The search processor is configured to receive a search keyword submitted from a user terminal, retrieve from the information memory individual webpages with content containing the search keyword, and generate a search result list comprising one or more search result item, wherein each search result item comprises a URL of a corresponding webpage and its ranking score R_score. The information security degree memory is configured to store information on information security degree of one or more webpage, the information on information security degree of each webpage comprising at least the URL of the webpage and the information security degree IS_score of the webpage. The post-search processor is configured to obtain the search result list from the search processor, obtain from the information security degree memory information on information security degree of a webpage according to the URL of the corresponding webpage in each search result item of the search result list, generate a new ranking score NR_score of a webpage according to the ranking score R_score and the information security degree IS_score of the webpage, and update the ranking score R_score in a corresponding search result item in the search result list with the new ranking score NR_score so as to re-rank and generate a new search result list.

According to another aspect of the disclosure, there is further provided a corresponding search method running in a search server comprising an information memory and an information security degree memory, the information memory being configured to store webpage information collected from individual websites accessing the internet, the webpage information comprising at least content of a webpage and its URL, the information security degree memory being configured to store information on information security degree of one or more webpage, and the information on information security degree of each webpage comprising at least the URL of the webpage and the information security degree IS_score of the webpage.

The search method comprises the following steps of: receiving a search keyword submitted from a user terminal; retrieving from the information memory individual webpages with content containing the search keyword, and generating a search result list comprising one or more search result item, each search result item comprising a URL of a corresponding webpage and its ranking score R_score; obtaining from the information security degree memory information on information security degree of a webpage according to the URL of the corresponding webpage in each search result item of the search result list, generating a new ranking score NR_score of a webpage according to the ranking score R_score and the information security degree IS_score of the webpage, and updating the ranking score R_score in a corresponding search result item in the search result list with the new ranking score NR_score so as to re-rank and generate a new search result list.

The search server and search method provide search for a user and display the information security degree indicating the security and accuracy of the content of a corresponding webpage, such that the user can directly obtain a more secure and more accurate search result.

The above description is merely an overview of the technical solutions of the disclosure, in order that the technical means of the disclosure can be more clearly understood and they may be embodied according the content of the specification.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the disclosure. And throughout the drawings, like reference signs are used to denote like components. In the drawings:

FIG. 1 is a structural schematic diagram of a search server provided according to an embodiment of the disclosure;

FIG. 2 is a flow chart of a search method provided according to an embodiment of the disclosure;

FIG. 3 is a block diagram of a client or a server for performing a method according to the disclosure according to an embodiment of the disclosure; and

FIG. 4 is a storage unit for retaining or carrying a program code implementing a method according to the disclosure according to an embodiment of the disclosure.

### DETAILED DESCRIPTION OF THE INVENTION

The disclosure provides a search server and a search method providing information security degrees for a network search result, which will be described in detail in the following in connection with the drawings.

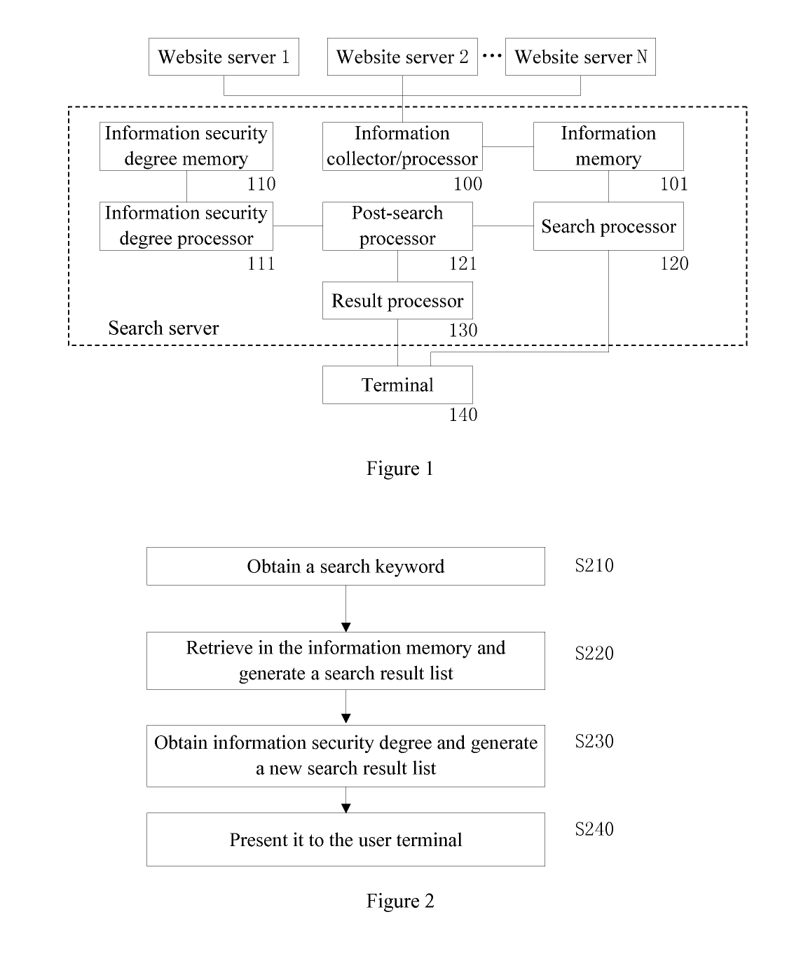

Referring to FIG. 1, a search server according to an embodiment of the disclosure comprises an information collector/processor 100, an information memory 101, an information security degree memory 110, an information security degree processor 111, a search processor 120 and a post-search processor 121. A user enters a search keyword through a user terminal 140, searches and obtains, via the search server of the disclosure, a search result with webpage information security degrees, and the result is presented to the user through the user terminal 140. In the disclosure, the user terminal may be a computer terminal, or may also be a mobile phone, various electronic devices capable of accessing to the internet, etc.

The information collector/processor 100 collects webpage information (which comprises at least content of a webpage and its URL, and of course, may also comprise other content as desired, for example, the type of the webpage, whether a virus, a Trojan, etc. have been embedded in the webpage) from individual website servers 1, 2 . . . N accessing to the internet, and stores it in the information memory 101. The way in which the information collector/processor 100 collects webpage information from individual website servers may be a traditional internet information search method, such as “spider”, “crawler”, etc., wherein an obtained webpage is processed, for example, a subject item, a keyword, a URL, an IP address, etc. are extracted, and the processed webpage is stored in the information memory 101.

The information security degree memory 110 stores information on information security degree of one or more webpage, the information on information security degree of each webpage comprising at least the URL of the webpage and its information security degree IS_score. The information security degree IS_score is a comprehensive score of whether the content corresponding to a URL is secure and accurate, and may be indicated in the form of 1-100 points; for example, if a certain webpage contains malicious content such as a Trojan, the information security degree IS_score of the webpage is 1; if a certain webpage has various potential vulnerabilities, e.g. such a vulnerability as XSS, SQL injection, etc., its information security degree IS_score may be set between 50 to 80 according to the number of vulnerabilities; and if a certain webpage does not have any security issue at all, its information security degree IS_score is 100. The information security degree IS_score may be set by various ways, for example, some network security devices installed on a personal computer will monitor the security situation of a webpage that a user is browsing, e.g., whether it contains a malicious link, whether it contains a Trojan, and the like, and set information security levels for the webpages, and the information security degree memory may obtain the information security degree of a webpage from such network security devices. However, it should be noted that, the disclosure is not limited thereto, all the ways that may provide the security condition of a webpage lie within the protection scope of the disclosure, for example, some network security devices dedicated to monitoring the network content, etc.

The search processor 120 receives a search keyword submitted by a user through a terminal, and retrieves it in the information memory 101 in a traditional way, to obtain a search result list from the information memory 101, the search result list comprising one or more search result item, each search result item being one piece of searched webpage information comprising the search keyword, wherein the webpage information may be a key-value pair, wherein the key is the URL of a corresponding webpage, and the value is the ranking score R_score (for the ranking of the search result) of the webpage.

Optionally, the search processor 120 may further pre-process the search keyword to generate a keyword which is more accurate for the search processor 120, and conduct retrieval in the information memory 101 utilizing the keyword.

After the completion of search, the search processor 120 passes the search result list to the post-search processor 121. According to the URL of the webpage in each search result item of the search result list, the post-search processor 121 obtains information on information security degree of a corresponding webpage from the information security degree memory 110 via the information security degree processor 111, and returns the information security degree IS_score of the corresponding webpage via the information security degree processor 111. Then, a new ranking score NR_score of the webpage is generated according to the ranking score R_score and the information security degree IS_score of the webpage.

In general, the new ranking score of the webpage is calculated according to the following formula

NR_score=IS_score*x+R_score*(1−x),

wherein x is a weight of the information security degree between 0 to 1, and according to an embodiment, the value of x may be 0.7.

Next, the ranking score R_score in the corresponding search result item in the search result list is updated with the new ranking score NR_score to re-rank and generate a new search result list.

Optionally, when the obtained information security degree IS_score is less than a specific value (e.g., less than 30), the post-search processor 121 automatically deletes from the search result list the search result item of the webpage corresponding to the information security degree IS_score, and thereby a search result with a too low information security degree will not be provided to the user.

Optionally, if the post-search processor 121 fails to obtain the information security degree IS_score of a certain webpage from the information security degree memory 110, then the post-search processor 121 will not calculate the new ranking score NR_score of the webpage, and will not update the ranking score R_score in a corresponding search result item in the search result list.

As described in FIG. 1, the search server further comprises a result processor 130. The result processor 130 receives the search result list from the post-search processor 121, generates a search result and presents it to the user terminal. Preferably, the search result presented to the user terminal comprises the information security degree of a corresponding webpage, that is, while individual webpages are presented according to the new ranking scores, also the information security degrees IS_score of the individual webpages are presented in a significant way.

FIG. 2 shows a flow chart of a search method according to an embodiment of the disclosure, which is adapted for running in the search server as shown in FIG. 1, and which begins at step S210, wherein a search keyword submitted from a user terminal is received. Optionally, after a search keyword is received at step S210, the search keyword may further be pre-processed to generate a keyword that is more accurate for the search processor. For example it comprises deleting some function words (e.g., “of”) in the search keyword, correcting some typos, and the like.

Next, at step S220, individual webpages with content containing the search keyword received at step S210 are retrieved from the information memory, and a search result list is generated comprising one or more search result item, each search result item comprising a URL of a corresponding webpage and its ranking score R_score. Optionally, this step may be done by the search processor.

Next, the method proceeds to step S230, wherein the information on information security degree of a webpage is obtained from the information security degree memory according to the URL of the corresponding webpage in each search result item of the search result list obtained at step S220, a new ranking score NR_score of the webpage is generated according to the ranking score R_score and the information security degree IS_score of the webpage, and the ranking score R_score in the corresponding search result item in the search result list is updated with the new ranking score NR_score to re-rank and generate a new search result list. This step may be done by the post-search processor 121.

In general, the new ranking score of the webpage is calculated according to the following formula

NR_score=IS_score*x+R_score*(1−x),

wherein x is a weight of the information security degree between 0 to 1, and according to an embodiment, the value of x may be 0.7.

Optionally, when the obtained information security degree IS_score is less than a specific value (e.g., less than 30), at step S230, the search result item of the webpage corresponding to the information security degree IS_score is automatically deleted from the search result list, and thereby a search result with a too low information security degree will not be provided to the user.

Optionally, if, at step S230, the information security degree IS_score of a certain webpage fails to be obtained, then a new ranking score NR_score of the webpage will not be calculated, and the ranking score R_score in a corresponding search result item in the search result list will not be updated.

Next, the search method proceeds to step S240, wherein a new search result list is processed and presented to the user terminal. Optionally, this step may be done by the result processor 130.

From the above, the search server and the search method according to the disclosure introduce the information security degree indicating the security condition of network content in determining a search result, provide for a user a ranking of the search content with a higher information security degree, and facilitate the user to more easily find a secure webpage.

Embodiments of the individual components of the disclosure may be implemented in hardware, or in a software module running on one or more processors, or in a combination thereof. It will be appreciated by those skilled in the art that, in practice, some or all of the functions of some or all of the components in a device according to individual embodiments of the disclosure may be realized using a microprocessor or a digital signal processor (DSP). The disclosure may also be implemented as a device or apparatus program (e.g., a computer program and a computer program product) for carrying out a part or all of the method as described herein. Such a program implementing the disclosure may be stored on a computer readable medium, or may be in the form of one or more signals. Such a signal may be obtained by downloading it from an Internet website, or provided on a carrier signal, or provided in any other form.

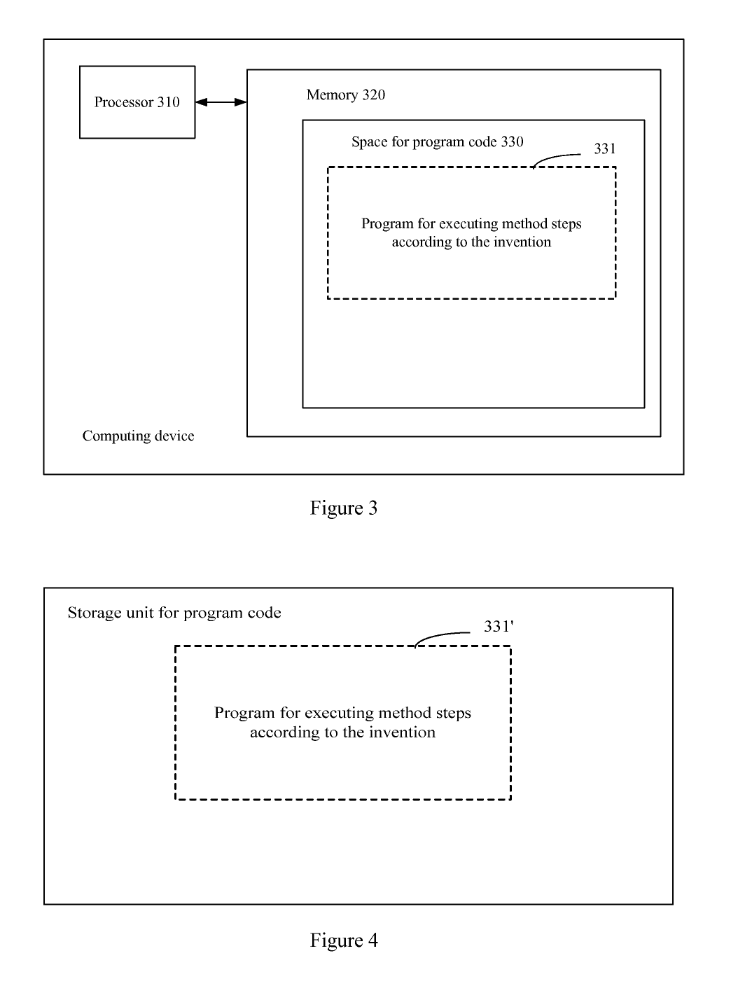

For example, FIG. 3 shows a computing device which may carry out a method of the disclosure, wherein the computing device may be a client or a server which can implement a method of the disclosure. The client or server traditionally comprises a processor 310 and a computer program product or a computer readable medium in the form of a memory 320. The memory 320 may be an electronic memory such as a flash memory, an EEPROM (electrically erasable programmable read-only memory), an EPROM, a hard disk or a ROM. The memory 320 has a memory space 330 for a program code 331 for carrying out any method steps in the methods as described above. For example, the memory space 330 for a program code may comprise individual program codes 331 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 4. The storage unit may have a memory segment, a memory space, etc. arranged similarly to the memory 320 in the client or server of FIG. 3. The program code may for example be compressed in an appropriate form. In general, the storage unit comprises a computer readable code 331′, i.e., a code which may be read by e.g., a processor such as 310, and when run by a server, the codes cause the server to carry out individual steps in the methods described above.

“An embodiment”, “the embodiment” or “one or more embodiments” mentioned herein implies that a particular feature, structure or characteristic described in connection with an embodiment is included in at least one embodiment of the disclosure. In addition, it is to be noted that, examples of a phrase “in an embodiment” herein do not necessarily all refer to one and the same embodiment.

In the specification provided herein, a plenty of particular details are described. However, it can be appreciated that an embodiment of the disclosure may be practiced without these particular details. In some embodiments, well known methods, structures and technologies are not illustrated in detail so as not to obscure the understanding of the specification.

It is to be noted that the above embodiments illustrate rather than limit the disclosure, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The disclosure may be implemented by means of a hardware comprising several distinct elements and by means of a suitably programmed computer. In a unit claim enumerating several means, several of the means may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the disclosure. Therefore, for those of ordinary skills in the art, many modifications and variations are apparent without departing the scope and spirit of the appended claims. For the scope of the disclosure, the disclosure of the disclosure is illustrative, but not limiting, and the scope of the disclosure is defined by the appended claims.

1. A search server, comprising
an information memory configured to store webpage information collected from individual websites accessing the internet, the webpage information comprising at least content of a webpage and its URL;
a search processor configured to receive a search keyword submitted from a user terminal, retrieve from the information memory individual webpages with content containing the search keyword, and generate a search result list comprising one or more search result item, each search result item comprising a URL of a corresponding webpage and its ranking score R_score;
an information security degree memory configured to store information on information security degree of one or more webpage, the information on information security degree of each webpage comprising at least the URL of the webpage and the information security degree IS_score of the webpage; and
a post-search processor configured to obtain the search result list from the search processor, obtaining from the information security degree memory information on information security degree of a webpage according to the URL of the corresponding webpage in each search result item of the search result list, generate a new ranking score NR_score of the webpage according to the ranking score R_score and the information security degree IS_score of the webpage, and update the ranking score R_score in a corresponding search result item in the search result list with the new ranking score NR_score so as to re-rank and generate a new search result list.

2. The search server as claimed in claim 1, wherein the new ranking score
NR_score=IS_score*x+R_score*(1−x),
wherein x is a weight of the information security degree between 0 to 1.

3. The search server as claimed in claim 2, wherein the weight of the information security degree x=0.7.

4. The search server as claimed in claim 1, wherein
when the obtained information security degree IS_score is less than a specific value, the post-search processor automatically deletes from the search result list the search result item of the webpage corresponding to the information security degree IS_score.

5. The search server as claimed in claim 4, wherein
the information security degree IS_score is between 1 to 100; and
when the obtained information security degree IS_score is less than 30, the post-search processor automatically deletes from the search result list the search result item of the webpage corresponding to the information security degree IS_score.

6. The search server as claimed in claim 1, wherein the search result item of the new search result list further comprises the information security degree IS_score of a corresponding webpage.

7. The search server as claimed in claim 1, wherein
if the post-search processor fails to obtain the information on information security degree of a corresponding webpage from the information security degree memory, then the post-search processor will not calculate the new ranking score NR_score of the webpage, and will not update the ranking score R_score in the corresponding search result item in the search result list.

8. The search server as claimed in claim 1, further comprising
a result processor configured to obtain the new search result list from the post-search processor, generate a search result and present it to the user terminal.

9. A search method running in a search server comprising an information memory and an information security degree memory, the information memory configured to store webpage information collected from individual websites accessing the internet, the webpage information comprising at least content of a webpage and its URL, the information security degree memory configured to store information on information security degree of one or more webpage, and the information on information security degree of each webpage comprising at least the URL of the webpage and the information security degree IS_score of the webpage; the method comprises the following steps of:
receiving a search keyword submitted from a user terminal;
retrieving from the information memory individual webpages with content containing the search keyword, and generating a search result list comprising one or more search result item, each search result item comprising a URL of a corresponding webpage and its ranking score R_score;
obtaining from the information security degree memory information on information security degree of a webpage according to the URL of the corresponding webpage in each search result item of the search result list, generating a new ranking score NR_score of the webpage according to the ranking score R_score and the information security degree IS_score of the webpage, and updating the ranking score R_score in a corresponding search result item in the search result list with the new ranking score NR_score so as to re-rank and generate a new search result list.

10. The search method as claimed in claim 9, wherein the new ranking score
NR_score=IS_score*x+R_score*(1−x),
wherein x is a weight of the information security degree between 0 to 1.

11. The search method as claimed in claim 9, wherein
when the obtained information security degree IS_score is less than a specific value, the post-search processor automatically deletes from the search result list the search result item of the webpage corresponding to the information security degree IS_score.

12. The search method as claimed in claim 11, wherein
the information security degree IS_score is between 1 to 100; and
when the obtained information security degree IS_score is less than 30, the post-search processor automatically deletes from the search result list the search result item of the webpage corresponding to the information security degree IS_score.

13. The search method as claimed in claim 9, wherein the search result item of the new search result list further comprises the information security degree IS_score of a corresponding webpage.

14. The search method as claimed in claim 9, wherein
if the information on information security degree of a corresponding webpage fails to be obtained from the information security degree memory, then the new ranking score NR_score of the webpage will not be calculated, and the ranking score R_score in the corresponding search result item in the search result list will not be updated.

15. The search method as claimed in claim 9, further comprising
obtaining the new search result list, generating a search result and presenting it to the user terminal.

16. (canceled)

17. A non-transitory computer readable medium having instructions stored thereon that, when executed by at least one processor, cause the at least one processor to perform operations for a search method running in a search server comprising an information memory and an information security degree memory, the information memory configured to store webpage information collected from individual websites accessing the internet, the webpage information comprising at least content of a webpage and its URL, the information security degree memory configured to store information on information security degree of one or more webpage, and the information on information security degree of each webpage comprising at least the URL of the webpage and the information security degree IS_score of the webpage, the search method comprising the steps of:
receiving a search keyword submitted from a user terminal;
retrieving from the information memory individual webpages with content containing the search keyword, and generating a search result list comprising one or more search result item, each search result item comprising a URL of a corresponding webpage and its ranking score R_score;
obtaining from the information security degree memory information on information security degree of a webpage according to the URL of the corresponding webpage in each search result item of the search result list, generating a new ranking score NR_score of the webpage according to the ranking score R_score and the information security degree IS_score of the webpage, and updating the ranking score R_score in a corresponding search result item in the search result list with the new ranking score NR_score so as to re-rank and generate a new search result list.
